(19) United States
(12) Patent Application Publication
(10) Pub. No.: US 2002/0047955 A1
(43) Pub. Date: Apr. 25, 2002

(54) Flat panel display having a substrate of low transmittance

(76) Inventors: Eu-Gene Kim, Geonggi-do (KR); Ji-Young Ahn, Gyeonggi-do (KR)

Correspondence Address: BIRCH STEWART KOLASCH & BIRCH, PO BOX 747, FALLS CHURCH, VA, 22040-0747, US

(21) Appl. No.: 09/983,268

(22) Filed: Oct. 23, 2001

(30) Foreign Application Priority Data
Oct. 23, 2000 (KR) 2000-62210

(51) Int. Cl. G02F 1/1335

(52) U.S. Cl. 349/61

(57) ABSTRACT

A flat panel display device including a first substrate formed of a first material; a second substrate spaced apart from the first substrate and formed of a second material; and a plurality of pixelated emissive devices interposed between the first and second substrates. The second material having a relatively higher light transmittance property than the first material, and the second substrate transmitting light for the plurality of pixelated emissive devices.

### FIELD OF THE INVENTION

The present invention relates to a flat panel display device, and more particularly to a reflective liquid crystal display device.

### BACKGROUND OF THE INVENTION

As information technologies rapidly develop, display devices are developed in accordance with the pace of the technology development. The display devices process and display a great deal of information. A cathode ray tube (CRT) has served as a mainstream of the display device area. However, to meet the needs of the current development, a flat panel display device having small size, light weight, and low power consumption is an important subject of research.

The flat panel display (FPD) devices can be divided depending on whether a light source is used or not. Emissive display devices, which display the images by the luminescence, include the plasma display panel (PDP), the field emission display (FED) and the electroluminiscence display (ELD). On the other hand, non-emissive display devices, which display the images by using the exterior light sources, are represented by the liquid crystal display (LCD) that is widely used due to a high resolution a color display and a high quality of images.

Generally, typical LCD devices include an upper and a lower substrate with liquid crystal molecules interposed therebetween. The upper and lower substrates are generally referred to as a color filter and array substrates respectively. The upper and lower substrates respectively include electrodes disposed on opposing surfaces of the upper and lower substrates. Since typical LCD devices can not emit the light, the light source is needed. Therefore, the backlight is disposed at the rear side of the liquid crystal panel and images can be displayed by adjusting the transmittance of the incident light from the backlight corresponding to the liquid crystal alignment.

An electric field is generated by applying a voltage to the electrodes made of transparent conductive materials, thereby driving the liquid crystal molecules per each pixel to display images depending on the light transmittance. Both substrates of the LCD devices are transparent because they have to transmit the light of the backlight. Glass substrates are mainly used as the substrates of the LCD devices and transmit about 90% to 95% of the incident light.

This type of LCD device is called a transmission type LCD. Since the transmission type LCD devices use an artificial rear light source, they can display bright images under a dark environment. However, the power consumption of the transmission type LCD devices is high owing to the backlight.

To reduce power consumption, reflection type LCD devices are suggested. The power consumption of the reflection type LCD devices is lower than that of transmission type LCD devices because they reflect the exterior natural or artificial light (the ambient light) and then use the reflected light as a light source. Therefore, the electrode of the lower substrate is made good reflective materials and the electrode of the upper substrate is made of transparent materials.

Since the price of LCD devices is high, there are many attempts to reduce the fabrication cost during the development of the materials or a decrease in the number of fabrication steps. Furthermore, the low cost is also an important object in the field of the emissive display devices, for example, ELD, FED and PDP.

### BRIEF SUMMARY OF THE INVENTION

Accordingly, the present invention is directed to the reflective liquid crystal display device that substantially obviates one or more of the problems due to limitations and disadvantages of the related art.

An object of the present invention is to provide an flat panel display (FPD) device, which can reduce the fabrication cost.

To achieve these and other advantages and in accordance with the purpose of the present invention, as emobidied and broadly described, a flat panel display device includes a first substrate formed of a first material; a second substrate spaced apart from the first substrate and formed of a second material having a relatively higher light transmittance property than the first material; and a plurality of pixelated emissive devices interposed between the first and second substances.

In another aspect, a reflective liquid crystal display device includes a first substrate formed of a first material; a second substrate spaced apart from the first substrate and for transmitting light into and out of the liquid crystal display device, the second substrate formed of a second material having a relatively higher light transmittance property than the first material; at least one pixel electrode on the first substrate for reflecting incident light towards the second substrate; and a liquid crystal layer interposed between the pixel electrode and the second substrate.

In a further aspect, an emissive display device includes a first substrate formed of a first material; a second substrate spaced apart from the first substrate and formed of a second material having a relatively higher light transmittance property than the first material; and a light emitting layer disposed between the first substrate and the second substrate and including phosphor.

Other features and characteristics of the present invention; methods, operation, and functions of the related elements of the structure; combination of parts; and economies of manufacture will become apparent from the following detailed description of the preferred embodiments and accompanying drawings, all of which form a part of this specification.

### BRIEF DESCRIPTION OF THE DRAWINGS

The present invention will become more fully understood from the detailed description given hereinbelow and the accompanying drawings which are given by way of illustration only, wherein like reference numerals designate corresponding parts in the various drawings and wherein;

FIG. 1 is a plane view of a reflective liquid crystal display device according to a preferred embodiment of the present invention;

FIG.2 is a cross-sectional view of a reflective liquid crystal display device according to a preferred embodiment of the present invention taken along line II-II of FIG. 1;

FIG. 3 is a cross-sectional view of an electroluminiscence display according to a second embodiment of the invention;

FIG. 4 is a cross-sectional view of a field emission display according to a third embodiment of the invention; and

FIG. 5 is a cross-sectional view of a plasma display panel according to the fourth embodiment of the invention.

### DETAILED DESCRIPTION OF PREFERRED EMBODIMENTS

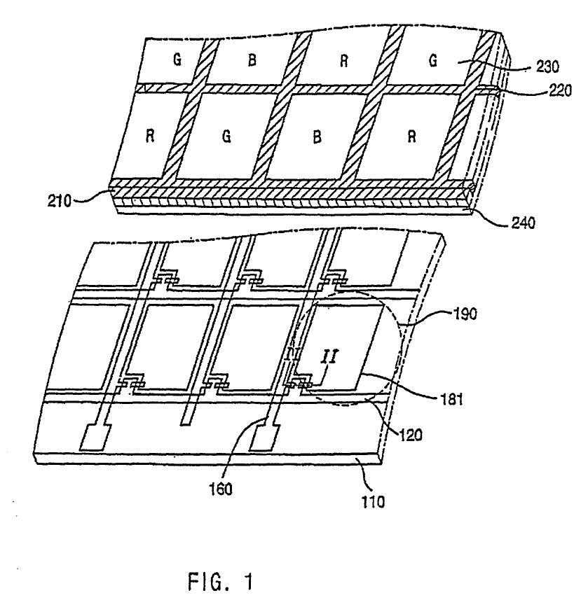

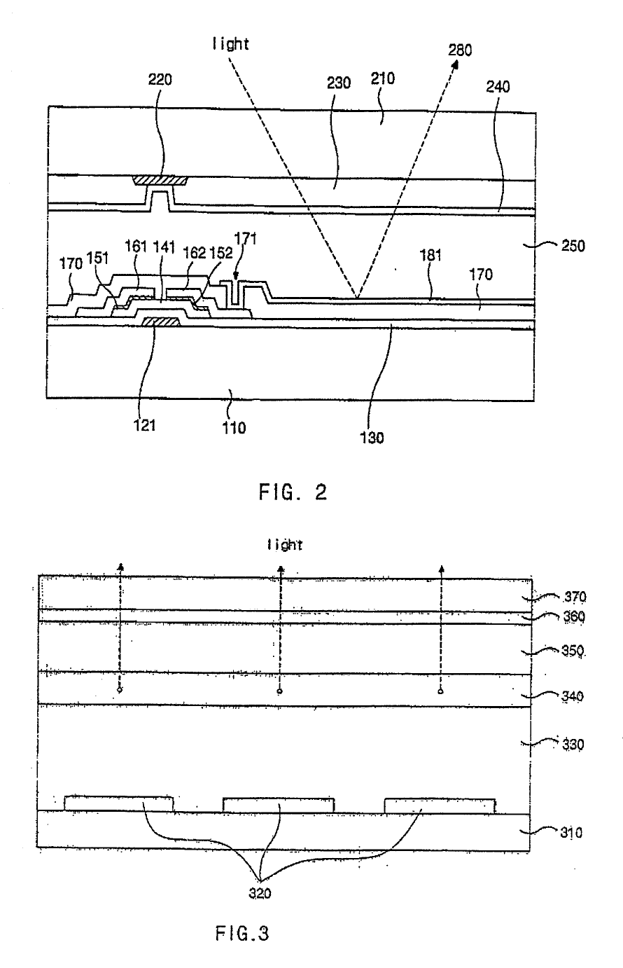

FIG. 1 is a plane view of a reflective liquid crystal display device according to a preferred embodiment of the present invention and FIG. 2 is a cross-sectional view of a reflective liquid crystal display device according to a preferred embodiment of the present invention taken along line II-II of FIG. 1.

As shown, a gate electrode 121 is patterned on a lower first substrate 110 and connected with a gate line 120. A gate insulator 130 is formed on the entire surface of the first substrate 110, except for the area of the first substrate 110 covered by the gate electrode 121. An active layer 141 of amorphous silicon is patterned on the gate insulator 130. The ohmic contact layers 151 and 152 are formed from doped amorphous silicon and are patterned on active layer 141. A source electrode 161 and drain electrode 162 are patterned on the ohmic contact layers 151 and 152, active layer 141 and gate insulator 130. The source and drain electrodes 161 and 162 constitute the thin film transistor with the gate electrode 121. The source electrode 161 is connected with the data line 160, which defines the pixel region 190 by perpendicularly crossing the gate line 120. A passivation layer 170 covers the source and drain electrodes 161 and 162, and a contact hole 171 is patterned in the passivation layer 170 over the drain electrode 162. A metallic pixel electrode 181 is patterned on the passivation layer 170 of the pixel region and connected with the drain electrode 162 through the contact hole 171.

The pixel electrode 181 functions as a reflective film and reflects the incident light. Materials of low resistance and high reflectance, for example, aluminum or aluminum alloy are adequate for the pixel electrode 181. In other embodiments, the reflective film can be formed by other layers, for example, the source and drain electrodes 161 and 162.

A second substrate 210 is spaced apart from the first substrate 110, and a black matrix 220 is patterned on the inner surface of the second substrate 210 at the position corresponding to the thin film transistor and non-pixel region of the first substrate 110. Red, green and blue color filters 230 are patterned and overlap with the black matrix 220. A common electrode 240 generates the electric field with the pixel electrode 181 and is formed on the color filters 230.

A liquid crystal layer 250 is interposed between the first and second substrates 110, 210.

The dashed arrow 280 of FIG. 2 depicts a propagation route of the light, which is subsequently transmitted through the second substrate 210 and the liquid crystal layer 250, reflected at the pixel electrode 181 and then emitted through the liquid crystal layer 250 and the second substrate 210.

In the reflective LCD devices, the light passes the second substrate 210 twice and does not pass the first substrate 110. Therefore, though the transparent substrate of high transmittance is used for the second substrate 210, the adoption of the substrate that is not transparent or has relatively lower transmittance than the second substrate 210 for the first substrate 110 has little effect on the display quality.

In the present invention, the fabrication cost of the LCD device can be reduced by using a first substrate whose transmittance is relatively lower than the transmittance of the second substrate. For example, glass or plastic substrates can be used for the first substrate.

In another aspect, of the invention, the use of a first substrate with a relatively lower transmittance than the second substrate may be applied to other emissive display devices such as ELD, FED and PDP, which do not need the light source. For example, the backlight of the LCD devices and the light on the emissive display devices transmits only through the upper substrate.

FIG. 3 is a cross-sectional view of an electroluminiscence display according to a second embodiment of the invention. Upper electrode 360, lower electrode 320, upper insulator 350, lower insulator 330, and a thin film phosphor layer 340 are disposed between first and second substrates 310 and 370. The thin film phosphor layer 340 emits light when a high voltage is applied to the upper and lower electrodes 360 and 320. To display the images, the second substrate 370 and the upper electrode 360 are transparent. However, since the first substrate 310 is not used for displaying images, the first substrate 310 need not be transparent and can have a relatively low transmittance. For example, the lower substrate 310 may be composed of the same materials of the first substrate 110, as discussed above.

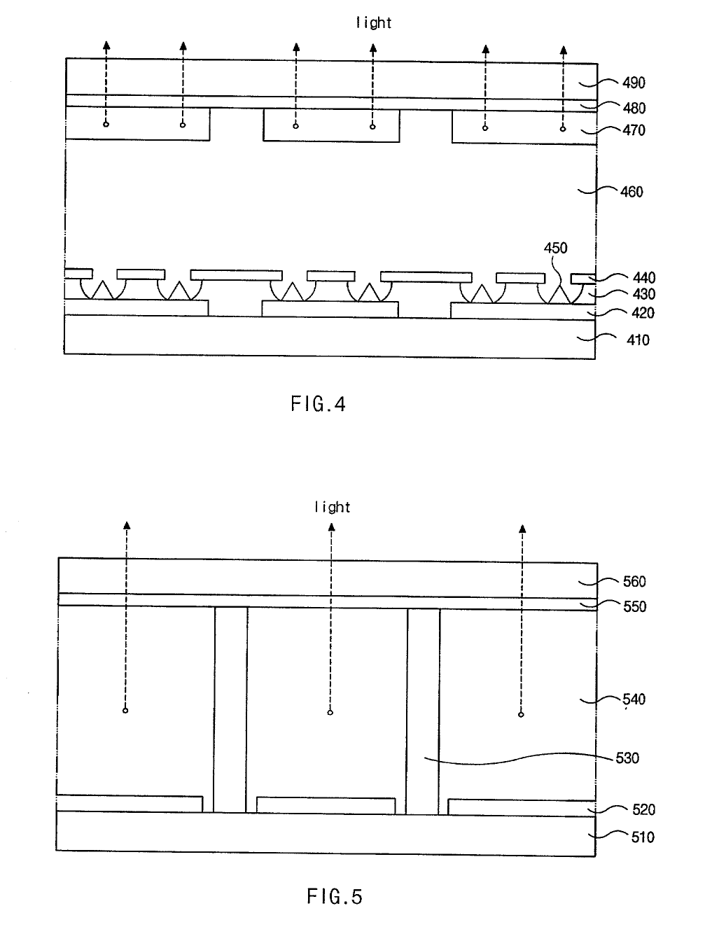

FIG. 4 is a cross-sectional view of a field emission display according to a third embodiment of the invention. Cathodes 420, insulators 430, gates 440 and tips 450 are formed on a first substrate 410, and anodes 480 and phosphors 470 are formed under a second substrate 490. The interspaces between the first and second substrates 410 and 490 are evacuated and form vacuum 460. Electrons are emitted from the tip 450 to vacuum 460 by the applied high voltage between the tip 450 and the gate 440 and accelerated by the voltage of the anode 480. The accelerated electrons collide with the phosphor 470 and then the phosphor 470 emits the light. Here, since only the light emitted to the second substrate 490 is used for displaying images, the first substrate 410 need not be transparent and can have a relatively low transmittance. The first substrate 410, for example, may be composed of the same materials as the first substrate 110.

FIG. 5 is a cross-sectional view of a plasma display panel according to a fourth embodiment of the invention. Upper and lower electrodes 550 and 520 are patterned on second and first substrates 560 and 510, respectively. An intermediate glass sheet 530 having small holes is interposed between the first and second substrates 510 and 560 and then the small holes are filled with phosphor 540. The phosphor 540 is discharged by the applied voltage between the upper and lower electrodes 550 and 520, and emits the light. Same as the above examples of the emissive display devices, since only the light emitted to the second substrate 560 is used for displaying images, the first substrate 510 need not be transparent and can have a relatively low transmittance. Further, the first substrate 510 may be composed, for example, of the same materials discussed above for the first substrate 110.

Consequently, in the case of the emissive display devices, though the substrate of high transmittance is used for the upper substrate, a material that is not transparent or has lower transmittance than the upper substrate can be used for the lower substrate.

The preferred embodiment of the invention being thus described, it will be obvious to those skilled in the art that various modifications and variation may be made in the invention without departing from the spirit or scope of the invention. Further, all such modifications are intended to be within the scope of the following claims.

What is claimed is:

1. A flat panel display device, comprising:
a first substrate formed of a first material;
a second substrate spaced apart from the first substrate and formed of a second material, said second material having a relatively higher light transmittance property than said first material;
a plurality of pixelated emissive devices interposed between the first and second substrates.

2. The device of claim 1, wherein
the second substrate transmits light from the plurality of pixelated emissive devices.

3. The display device of claim 1, wherein
the first material is glass or plastic.

4. The device of claim 1, wherein
the first material has a light transmittance property of less than 90%.

5. The device of claim 1, wherein
the first material does not transmit light.

6. The device of claim 1, wherein
the plurality of pixelated emmissive devices are electroluminescene devices.

7. A reflective liquid crystal display device, comprising:
a first substrate formed of a first material;
a second substrate spaced apart from the first substrate and for transmitting light into and out of the liquid crystal display device, said second substrate formed of a second material, and said second material having a relatively higher light transmittance property than said first material;
at least one pixel electrode on the first substrate for reflecting incident light towards the second substrate; and
a liquid crystal layer interposed between the pixel electrode and the second substrate.

8. The device of claim 7, further comprising:
a plurality of gate lines and a plurality of data lines perpindicularly crossing each other defining pixel regions;
a plurality of thin film transistors electrically connected with the corresponding gate and data lines; and
a plurality of pixel electrodes on the first substrate for reflecting incident light towards the second substrate and connected with the plurality of thin film transistors at the pixel region.

9. The device of claim 7, further comprising:
a black matrix on the second substrate;
a color filter on the black matrix; and
a transparent electrode on the color filter, said transparent electrode for generating an electric field with the corresponding pixel electrodes,wherein
the liquid crystal layer is between the pixel electrodes and the transparent electrode.

10. The device of claim 7, wherein the first material is glass or plastic.

11. The device of claim 7, wherein
the first material has a light transmittance property of less than 90%.

12. The device of claim 7, wherein
the first material does not transmit light.

13. An emissive display device, comprising
a first substrate formed of a first material;
a second substrate spaced apart from the first substrate and formed of a second material, said second material having a relatively higher light transmittance property than said first material;
a light emitting layer disposed between the first substrate and the second substate, said light emitting layer including phosphor.

14. The device of claim 13, wherein
the second substrate transmits light emitted from the light emitting layer.

15. The display device of claim 13, wherein
the first material is glass or plastic.

16. The device of claim 13, wherein
the first material has a light transmittance property of less than 90%.

17. The device of claim 13, wherein
the first material does not transmit light.

18. The device of claim 13, wherein
the light emitting layer is on the second substrate.

19. The device of claim 13, wherein
the light emitting layer is spaced apart from the first substrate and the second substrate.
